(19) United States
(12) Patent Application Publication
(10) Pub. No.: US 2016/0065263 A1
(43) Pub. Date: Mar. 3, 2016

(54) DUAL BAND CONCURRENT TRANSCEIVER

(71) Applicant: QUALCOMM Incorporated, San Diego, CA (US)

(72) Inventors: Saihua Lin, Santa Clara, CA (US); Anup Savla, Santa Clara, CA (US)

(21) Appl. No.: 14/475,094

(22) Filed: Sep. 2, 2014

(51) Int. Cl. H04B 1/401; H04L 5/14

(52) U.S. Cl. CPC H04B 1/401; H04L 5/14

(57) ABSTRACT

A method and apparatus are disclosed for concurrently transmitting and/or receiving two or more communication signals by a wireless device. The communication signals may include signals described by two or more communication protocols, such as Wi-Fi communication signals and BLUETOOTH communication signals. For at least some embodiments, the Wi-Fi communication signals may be within a 2.4 GHz or 5 GHz frequency band. In some embodiments, the apparatus may include a configurable switch unit to couple the Wi-Fi communication signals and/or the BLUETOOTH communication signals to an antenna through a diplexer and a filter.

### TECHNICAL FIELD

The present embodiments relate generally to wireless communication devices, and specifically to wireless devices with a dual band concurrent transceiver.

### BACKGROUND OF RELATED ART

A wireless device may communicate with other wireless devices using one or more communication protocols. Some communication protocols may use the Industrial, Scientific and Medical (ISM) radio bands that include a frequency band near 2.4 GHz and a frequency band near 5.0 GHz. By way of example, communication protocols may include a BLUETOOTH® protocol set forth by the Bluetooth Special Interest Group, Wi-Fi protocols described by IEEE 802.11 specifications, a ZigBee protocol described by the ZigBee standard, and any other technically feasible communication protocol.

Wireless devices that support multiple communication protocols may require substantial die area when implemented as an integrated circuit. For example, some wireless devices may use separate signal processing devices and separate front end circuits (e.g., power amplifiers and low noise amplifiers) dedicated to particular communication protocols and/or frequency bands. Wireless devices supporting concurrent operation of two or more communication protocols may use comparatively more signal processing devices, further increasing die area. Wireless device costs may be directly proportional to die area. Thus, increased die area may adversely affect a cost of the wireless device and, therefore, any products incorporating the wireless device.

Thus, there is a need to support multiple, concurrent communication protocols in wireless devices with an area efficient approach.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A transceiver is disclosed that may support concurrent reception and/or transmission of two or more communication signals. The transceiver may include a dual band power amplifier (PA) comprising a first input coupled to an output of a first mixer, a second input coupled to an output of a second mixer, and an output coupled to a first node; a dual band low noise amplifier (LNA) comprising an input coupled to a second node, a first output coupled to an input of a third mixer, and a second output coupled to an input of a fourth mixer; a single band LNA comprising an input coupled to the first node and a first output coupled to the input of a third mixer; and a single band PA comprising an input coupled to the output of the second mixer and an output coupled to the second node.

A wireless device is disclosed that may support concurrent reception and/or transmission of two or more communication signals (e.g., that may operate according to different communication protocols). The wireless device may include a dual band power amplifier (PA) comprising a first input coupled to an output of a first mixer, a second input coupled to an output of a second mixer, and an output coupled to a first node; a dual band low noise amplifier (LNA) comprising an input coupled to a second node, a first output coupled to an input of a third mixer, and a second output coupled to an input of a fourth mixer; a single band LNA comprising an input coupled to the first node and a first output coupled to the input of a third mixer; and a single band PA comprising an input coupled to the output of the second mixer and an output coupled to the second node; a first baseband processor to process a first set of baseband signals, wherein an output of the first baseband processor is coupled to an input of the first mixer and an input of the first baseband processor is coupled to an output of the fourth mixer; and a second baseband processor to process a second set of baseband signals, wherein an input of the second baseband processor is coupled to an output of the third mixer and an output of the second baseband processor is coupled to an input of the second mixer.

### BRIEF DESCRIPTION OF THE DRAWINGS

The present embodiments are illustrated by way of example and are not intended to be limited by the figures of the accompanying drawings. Like numbers reference like elements throughout the drawings and specification.

FIG. 1 depicts an example network system within which the present embodiments may be implemented.

FIG. 2 shows one embodiment of a concurrent transceiver depicted in FIG. 1.

FIG. 3 shows one embodiment of the wireless device depicted in FIG. 1.

FIG. 4 shows another embodiment of the wireless device depicted in FIG. 1.

FIG. 5 shows yet another embodiment of the wireless device depicted in FIG. 1.

FIG. 6 shows an illustrative flow chart depicting an example operation for operating the wireless device of FIG. 1, in accordance with some embodiments.

### DETAILED DESCRIPTION

The present embodiments are described below in the context of Wi-Fi enabled devices for simplicity only. It is to be understood that the present embodiments are equally applicable for devices using signals of other various wireless standards or protocols. As used herein, the terms “wireless local area network (WLAN)” and “Wi-Fi” may include communications governed by the IEEE 802.11 standards, BLUETOOTH®, HiperLAN (a set of wireless standards, comparable to the IEEE 802.11 standards, used primarily in Europe), and other technologies used in wireless communications.

In the following description, numerous specific details are set forth such as examples of specific components, circuits, and processes to provide a thorough understanding of the present disclosure. The term “coupled” as used herein means coupled directly to or coupled through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

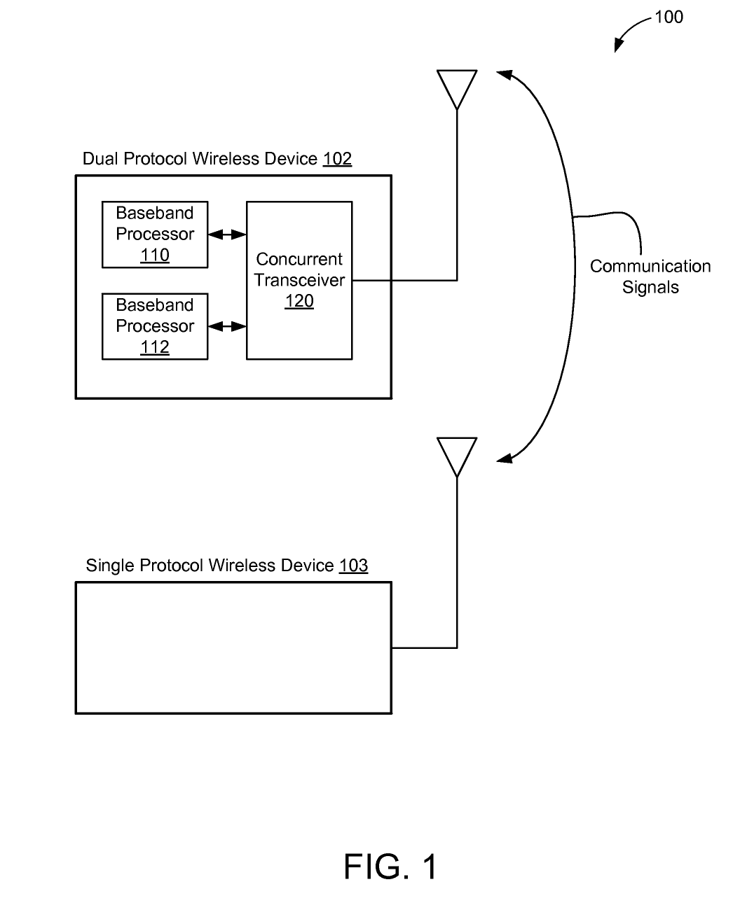

FIG. 1 depicts an example network system 100 within which the present embodiments may be implemented. Network system 100 includes a wireless device 102 and a wireless device 103. Wireless device 102 may be any suitable wireless device supporting two or more communication protocols. Example wireless devices 102 may include cell phones, smart phones, laptop computers, tablet computers, wireless access points, and the like. Wireless device 102 may be a dual protocol device and may concurrently process (e.g., transmit and/or receive) two different communication signals associated with two different communication protocols. For example, wireless device 102 may concurrently process Wi-Fi and BLUETOOTH® communication signals.

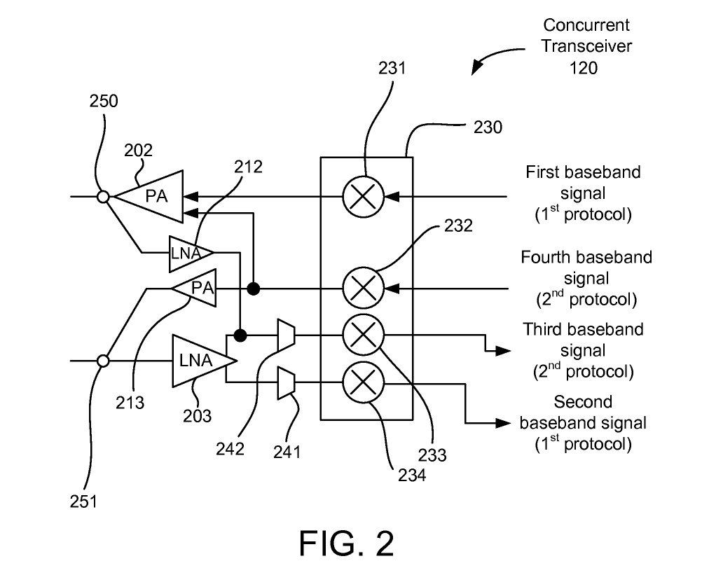

In some embodiments, wireless device 102 may include a concurrent transceiver 120, a first baseband processor 110, and a second baseband processor 112. In other embodiments, wireless device 102 may include more than two baseband processors. First baseband processor 110 may process baseband signals associated with a first communication protocol and second baseband processor 112 may process baseband signals associated with a second communication protocol. The first baseband processor 110 and the second baseband processor 112 may be coupled to concurrent transceiver 120. Concurrent transceiver 120 may concurrently transmit and/or receive communication signals associated with the first communication protocol and the second communication protocol. Operation of concurrent transceiver 120 is described in more detail below in conjunction with FIG. 2.

As mentioned above, network system 100 may also include a single protocol wireless device 103. Communication signals may be transmitted between wireless device 102 and single protocol wireless device 103. In some embodiments, single protocol wireless device 103 may transmit and/or receive communication signals via one of the communication protocols used by wireless device 102. For example, if wireless device 102 transmits and/or receives both Wi-Fi and BLUETOOTH communication signals, then single protocol wireless device 103 may transmit and/or receive either Wi-Fi or BLUETOOTH communication signals.

Although only one dual protocol wireless device 102 is shown in network system 100, in other embodiments, network system 100 may include more than one dual protocol wireless device 102. Similarly, although only one single protocol wireless device 103 is shown in network system 100, in other embodiments, network system 100 may include more than one single protocol wireless device 103. Although not shown for simplicity, single protocol wireless device 103 may include one of the first baseband processor 110 and second baseband processor 112. Single protocol wireless device 103 may also include a transceiver (not shown for simplicity) to transmit and/or receive a communication signal associated with single protocol wireless device 103.

FIG. 2 shows one embodiment of concurrent transceiver 120 of FIG. 1. Concurrent transceiver 120 includes a dual band power amplifier (PA) 202, a dual band low noise amplifier (LNA) 203, a single band LNA 212, a single band PA 213, and a mixer block 230. In some embodiments, dual band PA 202 and dual band LNA 203 may each operate within two different frequency bands. For example, dual band PA 202 and dual band LNA 203 may each amplify communication signals within 2.4 GHz and 5 GHz frequency bands. In some other embodiments, dual band PA 202 and dual band LNA 203 may have sufficient bandwidth to operate in more than two frequency bands. In some embodiments, single band LNA 212 and single band PA 213 may each operate within a single frequency band. For example, single band LNA 212 and single band PA 213 may amplify communication signals within the 2.4 GHz frequency band (or alternately in the 5 GHz frequency band).

Mixer block 230 may include mixers to up-convert and down-convert signals to and from dual band PA 202, dual band LNA 203, single band LNA 212, and single band PA 213. In some embodiments, mixer block 230 includes four mixers 231-234. In other embodiments, mixer block 230 may include other numbers of mixers. Each mixer may “mix” together two input signals (e.g., multiply two signals together), and generate a third output signal based on a product of the two input signals.

In some embodiments, mixer 231 receives a first baseband signal that may be associated with the first communication protocol. Mixer 231 may mix the first baseband signal with a first oscillator signal (e.g., local oscillator signal LO₁, not shown for simplicity) to up-convert the first baseband signal to a first radio frequency (RF) signal. An output of mixer 231 may be coupled to a first input of dual band PA 202. Dual band PA 202 may amplify the output signal provided by mixer 231 to generate a first communication signal associated with the first communication protocol.

In some embodiments, dual band LNA 203 receives and amplifies a second communication signal provided by an antenna (not shown for simplicity). The second communication signal may also be associated with the first communication protocol. A first output of dual band LNA 203 may be coupled to mixer 234 through a first buffer 241. Mixer 234 may mix the buffered second communication signal with a second oscillator signal (e.g., local oscillator signal LO₂, not shown for simplicity) to down-convert the buffered second communication signal and generate a second baseband signal associated with the first communication protocol. In some embodiments, the first oscillator signal and the second oscillator signal may be selected to allow mixer 231 and mixer 234 to up-convert and down-convert signals (respectively) associated with the first communication protocol. For example, the first oscillator signal and the second oscillator signal may be selected to allow first Wi-Fi baseband signals to be up-converted by mixer 231 and 2.4 GHz or 5 GHz Wi-Fi communication signals to be down-converted by mixer 234 to generate the second baseband signal.

In some embodiments, single band LNA 212 receives and amplifies a third communication signal from an antenna (not shown for simplicity). The third communication signal may be associated with the second communication protocol. The amplified third communication signal is buffered by a second buffer 242 and provided to mixer 233. Mixer 233 may mix the buffered third communication signal with a third oscillator signal (e.g., local oscillator signal LO₃, not shown for simplicity) to down-convert the buffered third communication signal and generate a third baseband signal associated with the second communication protocol.

In some embodiments, mixer 232 receives a fourth baseband signal that may be associated with the second communication protocol. Mixer 232 may mix the fourth baseband signal with a fourth oscillator signal (e.g., local oscillator signal LO₄, not shown for simplicity) to up-convert the fourth baseband signal. An output from mixer 232 may be coupled to single band PA 213. The single band PA 213 may amplify the output signal provided by mixer 232 to generate a fourth communication signal associated with the second communication protocol. In some embodiments, the third oscillator signal and the fourth oscillator signal may be selected to allow mixer 232 and mixer 233 to up-convert and down-convert signals (respectively) associated with the second communication protocol. For example, the third oscillator signal and the fourth oscillator signal may be selected to allow BLUETOOTH baseband signals to be up-converted by mixer 232 to 2.4 GHz BLUETOOTH communication signals, and to allow 2.4 GHz BLUETOOTH communication signals to be down-converted by mixer 234 to BLUETOOTH baseband signals. In another example, the third oscillator signal and the fourth oscillator signal may be selected to allow Wi-Fi baseband signals to be up-converted by mixer 232 to 2.4 GHz or 5 GHz Wi-Fi communication signals, and to allow 2.4 GHz or 5 GHz Wi-Fi communication signals to be down-converted by mixer 234 to Wi-Fi baseband signals

In some embodiments, the frequency band used for the first communication protocol may be similar to the frequency band used for the second communication protocol. Thus, some PAs and/or LNAs may not be limited to processing signals associated with a single communication protocol. Instead, a PA and/or LNA may concurrently process signals for two or more communication protocols. For example, if a first communication protocol is associated with 2.4 GHz Wi-Fi communication signals and a second communication protocol is associated with BLUETOOTH communication signals, then dual band PA 202 and dual band LNA 203 may transmit and receive both 2.4 GHz Wi-Fi and BLUETOOTH communication signals.

In some embodiments, single band PA 213 and signal band LNA 212 may be coupled to dual band PA 202 and dual band LNA 203 to allow concurrent reception and processing of communication signals associated with at least two different communication protocols. For example, the output of dual band PA 202 may be coupled to an input of single band LNA 212 at a first node 250. Additionally, a second input of dual band PA 202 may be coupled to the output of mixer 232. The output of single band PA 213 may be coupled to the input of dual band LNA 203 at a second node 251. The dual band LNA 203 may include a second output that may be coupled to the output of the single band LNA 212 and the input of second buffer 242.

The arrangement of concurrent transceiver 120 described herein and depicted in FIG. 2 may allow concurrent processing of communication signals for two or more communication protocols. There are a number of possible configurations of concurrent transceiver 120. A few example configurations are described below to highlight possible operations of concurrent transceiver 120. The examples described below are not exhaustive and should not be construed as limiting.

In a first example, the first communication protocol is associated with 2.4 GHz Wi-Fi communication signals and the second communication protocol is associated BLUETOOTH communication signals. Both communication protocols may operate within the 2.4 GHz frequency band. To transmit a 2.4 GHz Wi-Fi communication signal concurrently with a BLUETOOTH communication signal, mixer 231 may receive and up-convert a Wi-Fi baseband signal to generate a 2.4 GHz Wi-Fi communication signal. Dual band PA 202 may amplify the 2.4 GHz Wi-Fi communication signal and provide the amplified 2.4 GHz Wi-Fi communication signal to first node 250. In some embodiments, dual band PA 202 may select signals from mixer 231 through the first input of PA 202. Mixer 232 may receive and up-convert a BLUETOOTH baseband signal to generate a 2.4 GHz BLUETOOTH communication signal. Single band PA 213 may amplify the BLUETOOTH communication signal and provide the amplified BLUETOOTH communication signal to second node 251. In this example, first node 250 may operate as a 2.4 GHz Wi-Fi communication signal output node and second node 251 may operate as a BLUETOOTH communication signal output node.

In a second example, the first communication protocol is again associated with 2.4 GHz Wi-Fi communication signals and the second communication protocol is associated with BLUETOOTH communication signals. To concurrently receive the 2.4 GHz Wi-Fi communication signal and the BLUETOOTH communication signal, dual band LNA 203 may receive and amplify the 2.4 GHz Wi-Fi communication signal received from second node 251. Mixer 234 may down-convert the amplified Wi-Fi communication signal from one output of dual band LNA 203 and generate a 2.4 GHz Wi-Fi baseband signal. Single band LNA 212 may receive and amplify the BLUETOOTH communication signal from first node 250. Mixer 233 may down-convert the amplified BLUETOOTH communication signal to generate a BLUETOOTH baseband signal. In this example, first node 250 may operate as a BLUETOOTH communication signal input node and second node 251 may operate as a 2.4 GHz Wi-Fi communication signal input node.

In a third example, the first communication protocol is associated with 5 GHz Wi-Fi communication signals and the second communication protocol is associated with BLUETOOTH communication signals. To concurrently transmit a 5 GHz Wi-Fi communication signal and receive a BLUETOOTH communication signal, a Wi-Fi baseband signal may be received and up-converted by mixer 231 to generate the 5 GHz Wi-Fi communication signal. The output of mixer 231 is coupled to dual band PA 202. Dual band PA 202 may amplify the output signal provided by mixer 231 and generate the 5 GHz Wi-Fi communication signal. The 5 GHz Wi-Fi communication signal is coupled to first node 250. A BLUETOOTH communication signal may be received at second node 251 and amplified by dual band LNA 203. The output of dual band LNA 203 is coupled to mixer 233 via second buffer 242. Mixer 233 may down-convert the buffered BLUETOOTH communication signal and generate a BLUETOOTH baseband signal. In this example, first node 250 may operate as a 5 GHz Wi-Fi communication signal output node and second node 251 may operate as a BLUETOOTH communication signal input node.

Many more configurations of concurrent transceiver 120 are possible. Table 1 describes some possible configurations of concurrent transceiver 120. In particular, Table 1 highlights possible operations, LNA/PA usage, and first node 250 and second node 251 assignments. Notably, Table 1 shows that first node 250 and second node 251 may be bidirectional nodes (e.g., the nodes 250 and 251 may function as an input node or an output node based on a desired operation). Table 1 is not meant to be an exhaustive list and does not limit the configurations of concurrent transceiver 120.

TABLE 1
Describing Possible Operations, LNA/PA Usage and Node
Assignments for Concurrent Transceiver 120

| | | | Second |
|---|---|---|---|
| Operation | LNA/PA usage | First Node: | Node: |
| 2.4 GHz Wi-Fi Rx | Dual band LNA | 2.4 GHz | 2.4 GHz Input |
| 2.4 GHz Wi-Fi Tx | Dual band PA | Output (Wi- | (BT) |
| | | Fi) | |
| 5 GHz Wi-Fi Rx | Dual band LNA | 5 GHz | 5 GHz Input |
| 5 GHz Wi-Fi Tx | Dual band PA | Output (Wi- | (BT) |
| | | Fi) | |
| BT Rx | Dual band LNA | 2.4 GHz | 2.4 GHz Input |
| BT Tx | Dual band PA | Output (BT) | (BT) |
| 2.4 GHz Wi-Fi Tx | Dual band PA | 2.4 GHz | Output (BT) |
| BT Tx | Single band LNA | Output | |
| | | (Wi-Fi) | |
| 2.4 GHz Wi-Fi Rx | Dual band LNA | n/a | 2.4 GHz Input |
| BT Rx | | | (Wi-Fi & BT) |
| 5 GHz Wi-Fi Tx | Dual band PA | 5 GHz | 2.4 GHz |
| BT Tx | Single band PA | Output | Output |
| | | (Wi-Fi) | (BT) |
| 5 GHz Wi-Fi Rx | Dual band LNA | 2.4 GHz | 5 GHz Input |
| BT Rx | Single band LNA | Input (BT) | (Wi-Fi) |
| 5 GHz Wi-Fi Tx | Dual band PA | 5 GHz | 2.4 GHz Input |
| BT Rx | Dual band LNA | Output | (BT) |
| | | (Wi-Fi) | |
| 5 GHz Wi-Fi Rx | Dual band LNA | 2.4 GHz | 5 GHz Input |
| BT Tx | Dual band PA | Output | (Wi-Fi) |
| | | (BT) | |

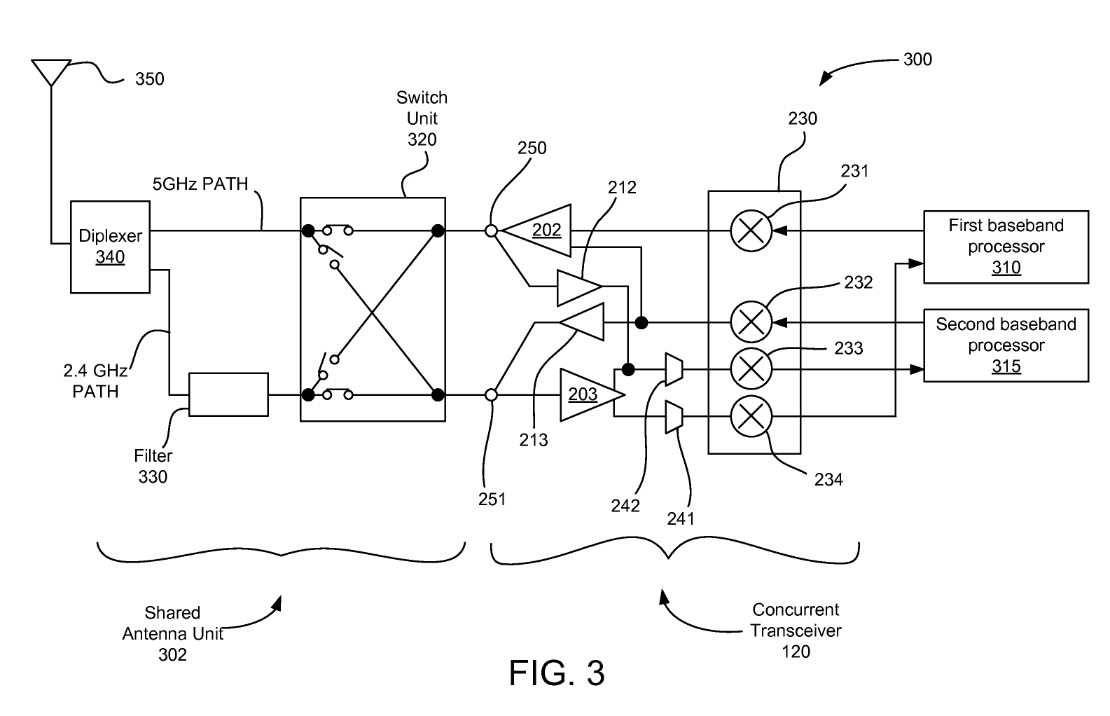

FIG. 3 shows a wireless device 300 that is one embodiment of wireless device 102 depicted in FIG. 1. Wireless device 300 includes concurrent transceiver 120 and a shared antenna unit 302. Concurrent transceiver 120 may include dual band PA 202, dual band LNA 203, single band LNA 212, single band PA 213, first buffer 241, second buffer 242, first node 250, second node 251, and mixer block 230 as described above in conjunction with FIG. 2. In some embodiments, wireless device 300 may include a first baseband processor 310 to process baseband signals according to the first communication protocol, and may include a second baseband processor 315 to process baseband signals according to the second communication protocol. For example, first baseband processor 310 may be a Wi-Fi baseband processor to process Wi-Fi baseband signals and second baseband processor 315 may be a BLUETOOTH baseband processor to process BLUETOOTH baseband signals.

First baseband processor 310 is coupled to mixer 231 and mixer 234. First baseband processor 310 may provide the first baseband signal to mixer 231 to generate the first communication signal (e.g., by up-converting the first baseband signal). In some embodiments, when first baseband processor 310 is a Wi-Fi baseband processor, a Wi-Fi baseband signal may be provided to mixer 231. First baseband processor 310 receives the second baseband signal from mixer 234. In some embodiments, when first baseband processor 310 is a Wi-Fi baseband processor, mixer 234 may down-convert a received Wi-Fi communication signal (e.g., the second communication signal) to generate the second Wi-Fi baseband signal.

Second baseband processor 315 is coupled to mixer 232 and mixer 233. Second baseband processor 315 may provide the third baseband signal to mixer 232 to generate the fourth communication signal (e.g., by up-converting the third baseband signal). In some embodiments, when second baseband processor 315 is a BLUETOOTH baseband processor, BLUETOOTH baseband signals may be provided to mixer 232. Second baseband processor 315 may receive the fourth baseband signal from mixer 233. In some embodiments, when second baseband processor 315 is a BLUETOOTH baseband processor, mixer 233 may down-convert a BLUETOOTH communication signal (e.g., the third communication signal) to generate a BLUETOOTH baseband signal.

Shared antenna unit 302 may include a switch unit 320, a filter 330, a diplexer 340, and an antenna 350. In some embodiments, switch unit 320 couples antenna 350 to concurrent transceiver 120 through first node 250 and second node 251. For example, switch unit 320 may couple first node 250 and/or second node 251 to diplexer 340. In one embodiment, switch unit 320 may be a double pole/double throw (DPDT) switch. In some embodiments, diplexer 340 allows two signals with different operating frequencies to be provided to antenna 350. For example, diplexer 340 may provide a 5 GHz path for 5 GHz communication signals and provide a 2.4 GHz path for 2.4 GHz communication signals. In some embodiments, switch unit 320 may couple the 5 GHz path to either first node 250 or second node 251. Similarly, switch unit 320 may couple the 2.4 GHz path to either first node 250 or second node 251.

In some embodiments, the 2.4 GHz path may include a filter 330. Filter 330 may remove and/or attenuate signals with frequencies that may interfere with 2.4 GHz communication signals. For example, filter 330 may be a coexistence filter to attenuate cellular signals (possibly received through antenna 350) from the 2.4 GHz path.

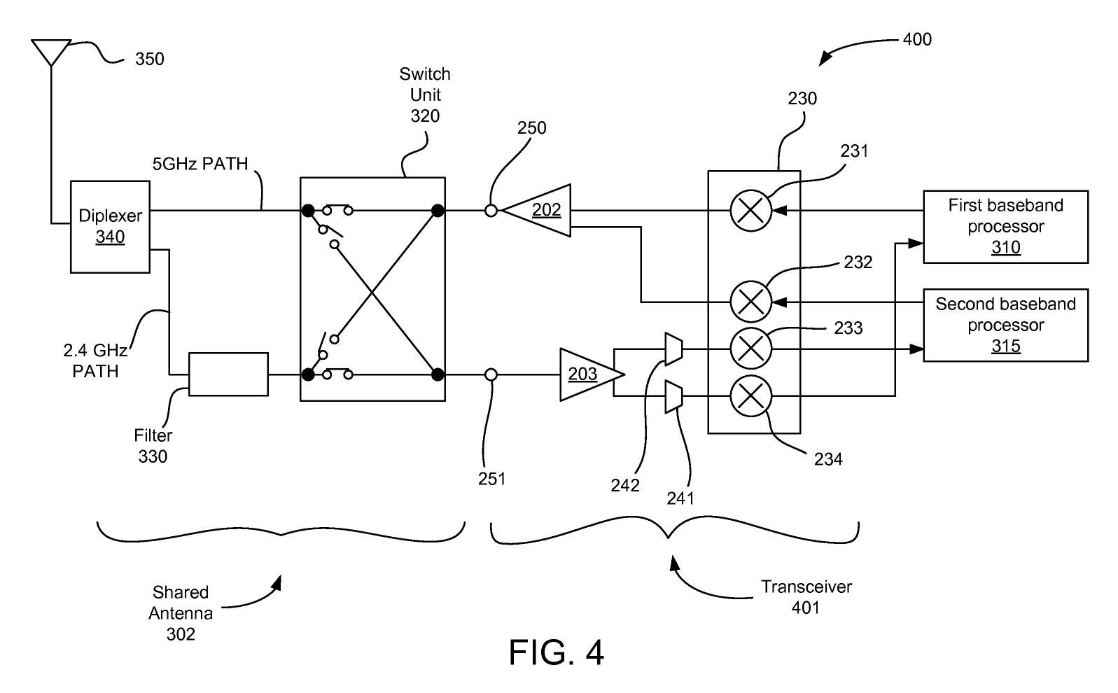

FIG. 4 shows a wireless device 400 that is another embodiment of the wireless device 102 depicted in FIG. 1. Wireless device 400 may include shared antenna unit 302, transceiver 401, first baseband processor 310, and second baseband processor 315. Shared antenna unit 302 may include switch unit 320, filter 330, diplexer 340, and antenna 350 similar to those described in conjunction with FIG. 3 above. First baseband processor 310 may process baseband signals associated with the first communication protocol and second baseband processor 315 may process baseband signals associated with the second communication protocol (as described above in conjunction with FIG. 3). In some embodiments, first baseband processor 310 may process Wi-Fi baseband signals and second baseband processor 315 may process BLUETOOTH baseband signals.

In some embodiments, transceiver 401 includes mixer block 230, dual band PA 202, dual band LNA 203, first buffer 241, and second buffer 242 similar to those described above in conjunction with FIGS. 2 and 3. Outputs of mixer 231 and mixer 232 are coupled to inputs of dual band PA 202. An output of dual band PA 202 is coupled to first node 250. Second node 251 is coupled to an input of dual band LNA 203. Outputs of dual band LNA 203 are coupled to mixer 233 and mixer 234 via second buffer 242 and first buffer 241, respectively. Outputs of mixer 233 and mixer 234 are coupled to second baseband processor 315 and first baseband processor 310, respectively. Inputs of mixer 231 and mixer 232 are coupled to first baseband processor 310 and second baseband processor 315, respectively. Shared antenna unit 302 may be coupled to first node 250 and second node 251.

Transceiver 401 may include fewer LNAs and PAs compared to concurrent transceiver 120 as described in FIGS. 1-3. As a result, in some embodiments, there may be fewer possible configurations of transceiver 401 compared to possible configurations of concurrent transceiver 120. For example, a configuration to concurrently transmit a 5 GHz Wi-Fi communication signal and a Bluetooth communication signal with transceiver 401 may not be feasible. In this example, dual band PA 202 amplifies both the 5 GHz Wi-Fi communication signal and the 2.4 GHz BLUETOOTH communication signal which, due to output power requirements of the respective communication signals, may not be possible. This example configuration is feasible using concurrent transceiver 120 (see Table 1, sixth row). The LNAs and PAs of transceiver 401 may use less die area, compared to concurrent transceiver 120. Thus, transceiver 401 may provide reduced functionality and reduced costs associated with wireless device 102.

In some embodiments, transceiver 401 may concurrently receive communication signals associated with a first communication protocol and a second communication protocol if both communication signals are within a similar frequency band (e.g., both communication signals are within the 2.4 GHz frequency band). If both communication signals are not within a similar frequency band, then only one communication signal related to one communication protocol may be received. For example, if transceiver 401 is to receive the 5 GHz Wi-Fi communication signal, then transceiver 401 may not be able to concurrently receive the 2.4 GHz BLUETOOTH communication signal.

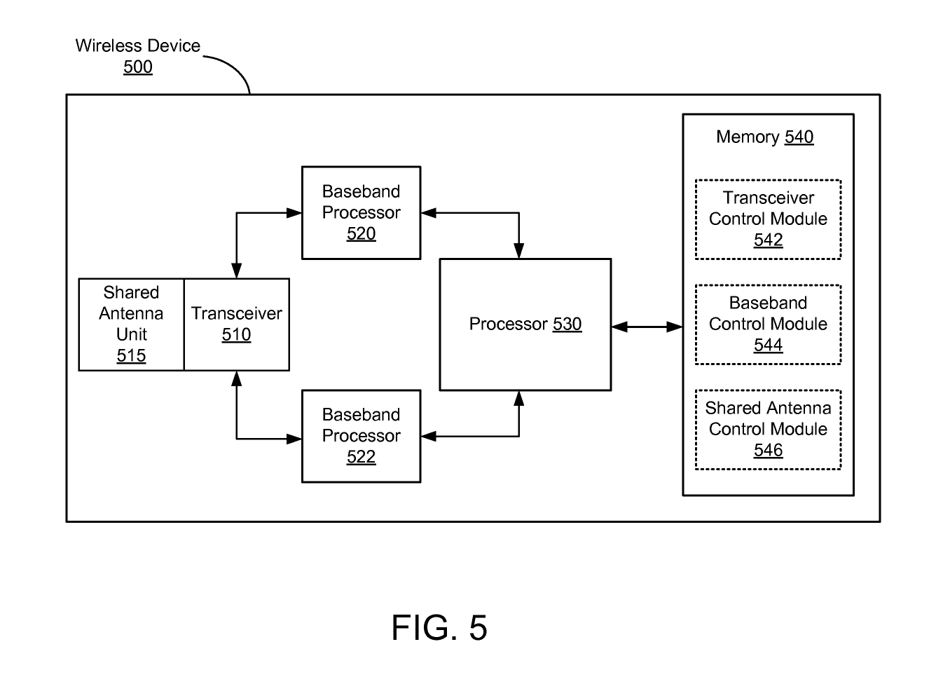

FIG. 5 shows a wireless device 500 that is another embodiment of wireless device 102 depicted in FIG. 1. Wireless device 500 includes a shared antenna unit 515, a transceiver 510, a first baseband processor 520, a second baseband processor 522, a processor 530, and a memory 540. Shared antenna unit 515 may couple an antenna (not shown for simplicity) to two separate communication signals. In some embodiments, the two separate communication signals may use different frequency bands. In some embodiments, shared antenna unit 515 may be similar to shared antenna unit 302 described in conjunction with FIGS. 3 and 4.

Transceiver 510 is coupled to shared antenna unit 515, first baseband processor 520, and second baseband processor 522. Transceiver 510 may up-convert baseband signals to RF communication signals and down-convert RF communication signals to baseband signals. In some embodiments, transceiver 510 may be similar to concurrent transceiver 120 described above in conjunction with FIGS. 1-3. First baseband processor 520 and second baseband processor 522 may process baseband signals with respect to a first communication protocol and a second communication protocol, respectively.

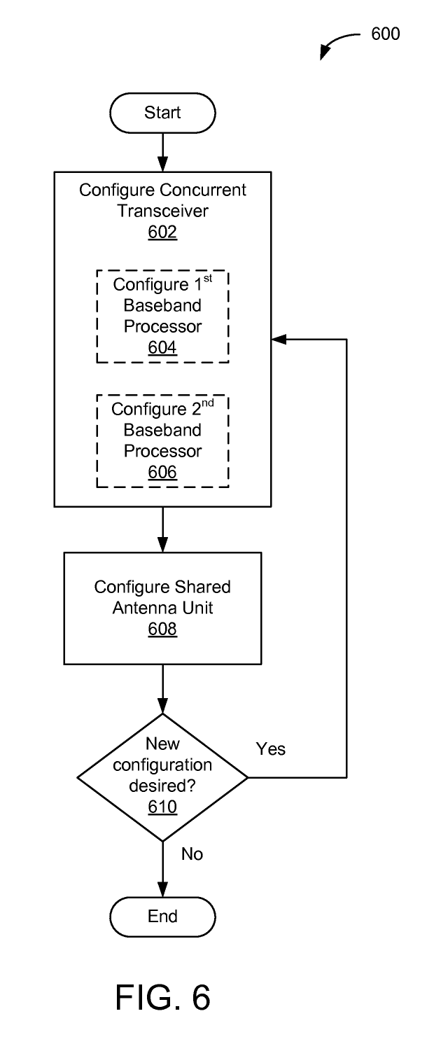

Memory 540 may include a non-transitory computer-readable storage medium (e.g., one or more nonvolatile memory elements, such as EPROM, EEPROM, Flash memory, a hard drive, etc.) that may store the following software modules:
a transceiver control module 542 to control up-converting and down-converting communication signals via transceiver 510;
a baseband control module 544 to control first baseband processor 520 and second baseband processor 522 to process baseband signals associated with the first communication protocol and the second communication protocol, respectively; and
a shared antenna control module 546 to control coupling of the antenna and transceiver 510 via shared antenna unit 515.
   Each software module includes program instructions that, when executed by processor 530, may cause the wireless device 500 to perform the corresponding function(s). Thus, the non-transitory computer-readable storage medium of memory 540 may include instructions for performing all or a portion of the operations of FIG. 6.

Processor 530, which is coupled to first baseband processor 520, second baseband processor 522, and memory 540, may be any suitable processor capable of executing scripts or instructions of one or more software programs stored in the wireless device 500 (e.g., within memory 540).

Processor 530 may execute transceiver control module 542 to configure transceiver 510 to up-convert and/or down-convert communication signals associated with the first communication protocol or the second communication protocol. Transceiver control module 542 may also control one or more LNAs and/or PAs included in transceiver 510 (not shown for simplicity).

Processor 530 may execute baseband control module 544 to control first baseband processor 520 and second baseband processor 522. For example, baseband control module 544 may cause first baseband processor 520 to process baseband signals according to a BLUETOOTH communication protocol and cause second baseband processor 522 to process baseband signals according to a Wi-Fi communication protocol.

Processor 530 may execute shared antenna control module 546 to control shared antenna unit 515. For example, execution of shared antenna control module 546 may cause a switch included in shared antenna unit 515 to couple the antenna to LNAs and/or PAs included in transceiver 510.

FIG. 6 shows an illustrative flow chart depicting an example operation 600 for operating wireless device 500, in accordance with some embodiments. Some embodiments may perform the operations described herein with additional operations, fewer operations, operations in a different order, operations in parallel, and/or some operations differently. Referring to FIGS. 1-3, wireless device 500 configures concurrent transceiver 120 (602). For example, wireless device 500 may operate concurrent transceiver 120 to transmit and/or receive first communication signals and/or second communication signals. In some embodiments, the first communication signals may be associated with a first communication protocol and the second communication signals may be associated with a second communication protocol.

Next, in some embodiments, wireless device 500 configures first baseband processor 310 (604). For example, wireless device 500 may configure first baseband processor 310 to process baseband signals according to the first communication protocol. Next, in some embodiments, wireless device 500 configures second baseband processor 315 (606). For example, wireless device 500 may configure second baseband processor 315 to process baseband signals according to the second communication protocol. In some embodiments, the first communication protocol is different from the second communication protocol. For example, the first communication protocol may be a Wi-Fi communication protocol and the second communication protocol may be a BLUETOOTH communication protocol.

Next, wireless device 500 configures shared antenna unit 302 (608). For example, wireless device 500 may configure shared antenna unit 302 to couple concurrent transceiver 120 to antenna 350. In some embodiments, wireless device 500 may cause switch unit 320 to couple first node 250 and/or second node 251 to antenna 350 through diplexer 340 and/or filter 330.

Next, wireless device 500 determines if a new configuration is desired (610). If a new configuration is desired, then flow proceeds to 602. If a new configuration is not desired, then flow ends.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A dual band transceiver comprising:
a dual band power amplifier (PA) comprising a first input coupled to an output of a first mixer, a second input coupled to an output of a second mixer, and an output coupled to a first node;
a dual band low noise amplifier (LNA) comprising an input coupled to a second node, a first output coupled to an input of a third mixer, and a second output coupled to an input of a fourth mixer;
a single band LNA comprising an input coupled to the first node and a first output coupled to the input of the third mixer; and
a single band PA comprising an input coupled to the output of the second mixer and an output coupled to the second node.

2. The transceiver of claim 1, further comprising:
an antenna;
a diplexer to couple the antenna to a first frequency path and a second frequency path; and
a switch unit to:
couple the first node to either the first frequency path or the second frequency path; and
couple the second node to either the first frequency path or the second frequency path.

3. The transceiver of claim 2, wherein the switch unit comprises a double pole/double throw configurable switch.

4. The transceiver of claim 2, wherein the first frequency path comprises a filter to attenuate cellular signals.

5. The transceiver of claim 2, wherein the first frequency path is to process a 2.4 GHz communication signal and the second frequency path is to process a 5 GHz communication signal.

6. The transceiver of claim 1, wherein the dual band PA and the dual band LNA are to operate according to a first communication protocol, and the signal band PA and the single band LNA are to operate according to a second communication protocol that is different from the first communication protocol.

7. The transceiver of claim 1, wherein the first mixer is to up-convert a baseband signal according to a first communication protocol and the fourth mixer is to down-convert a communication signal according to the first communication protocol.

8. The transceiver of claim 1, further comprising:
a first buffer to couple one of the first output of the dual band LNA and the output of the single band LNA to the input of the third mixer; and
a second buffer to couple the second output of the dual band LNA to the input of the fourth mixer.

9. A wireless device, comprising:
a transceiver comprising:
a dual band power amplifier (PA) comprising a first input coupled to an output of a first mixer, a second input coupled to an output of a second mixer, and an output coupled to a first node;
a dual band low noise amplifier (LNA) comprising an input coupled to a second node, a first output coupled to an input of a third mixer, and a second output coupled to an input of a fourth mixer;
a single band LNA comprising an input coupled to the first node and a first output coupled to the input of the third mixer; and
a single band PA comprising an input coupled to the output of the second mixer and an output coupled to the second node;
a first baseband processor to process a first set of baseband signals, wherein an output of the first baseband processor is coupled to an input of the first mixer, and an input of the first baseband processor is coupled to an output of the fourth mixer; and
a second baseband processor to process a second set of baseband signals, wherein an input of the second baseband processor is coupled to an output of the third mixer, and an output of the second baseband processor is coupled to an input of the second mixer.

10. The device of claim 9, wherein the first baseband processor is to process the first set of baseband signals according to a first communication protocol, and the second baseband processor is to process the second set of baseband signals according to a second communication protocol that is different from the first communication protocol.

11. The device of claim 10, wherein the first communication protocol is a protocol according to an IEEE 802.11 standard and the second communication protocol is a protocol according to a BLUETOOTH specification.

12. The device of claim 9, further comprising:
an antenna;
a diplexer to couple the antenna to a first frequency path and a second frequency path; and
a switch unit to:
couple the first node to either the first frequency path or the second frequency path; and
couple the second node to either the first frequency path or the second frequency path.

13. The device of claim 12, wherein the switch unit comprises a double pole/double throw configurable switch.

14. The device of claim 12, wherein the first frequency path comprises a filter to attenuate cellular signals.

15. The device of claim 12, wherein the first frequency path is to process a 2.4 GHz communication signal and the second frequency path is to process a 5 GHz communication signal.

16. The device of claim 9, wherein the dual band PA and the dual band LNA are to operate according to a first communication protocol, and the signal band PA and the single band LNA are to operate according to a second communication protocol that is different from the first communication protocol.

17. The device of claim 9, further comprising:
a first buffer to couple one of the first output of the dual band LNA and the output of the single band LNA the input of the third mixer; and
a second buffer to couple the second output of the dual band LNA to the input of the fourth mixer.

18. A wireless device, comprising:
a transceiver comprising:
a dual band power amplifier comprising a first input coupled to an output of a first mixer, a second input coupled to an output of a second mixer, and an output coupled to a first mode;
a dual band low noise amplifier comprising an input coupled to a second node, a first output coupled to an input of a third mixer, and a second output coupled to an input of a fourth mixer;
a first baseband processor to process a first set of baseband signals, wherein an output of the first baseband processor is coupled to an input of the first mixer and an input of the first baseband processor is coupled to an output of the fourth mixer; and
a second baseband processor to process a second set of baseband signals, wherein an input of the second baseband processor is coupled to an output of the third mixer and an output of the second baseband processor is coupled to an input of the second mixer.

19. The device of claim 18, wherein the first baseband processor is to process the first set of baseband signals according to a first communication protocol and the second baseband processor is to process the second set of baseband signals according to a second communication protocol, different from the first communication protocol.

20. The device of claim 18, wherein the transceiver further comprises:
an antenna;
a diplexer to couple the antenna a first frequency path and a second frequency path; and
a switch unit to couple the first node to the one of the first frequency path and the second frequency path and to couple the second node to one of the first frequency path and the second frequency path.
